(19) United States
(12) Patent Application Publication
(10) Pub. No.: US 2007/0035467 A1
(43) Pub. Date: Feb. 15, 2007

(54) Monopole broadband antenna

(75) Inventors: I-Fong Chen, Tao-Yuan City (TW); Chun-Sheng Huang, Pa-Te City (TW)

Correspondence Address: BRUCE H. TROXELL, SUITE 1404, 5205 LEESBURG PIKE, FALLS CHURCH, VA, 22041, US

(73) Assignee: Auden Techno Corp.

(21) Appl. No.: 11/200,021

(22) Filed: Aug. 10, 2005

(51) Int. Cl. H01Q 9/30

(52) U.S. Cl. 343/900; 343/702

(57) ABSTRACT

A monopole broadband antenna including a connecting segment for connecting an antenna circuit of a set of equipment, the connecting segment is provided thereon sequentially with a shaft portion with a small diameter and a shaft portion with a large diameter in connecting with the shaft portion with the small diameter; the shaft portion with the small diameter and the shaft portion with the large diameter together form the monopole broadband antenna. The antenna can be used for equipment such as a digital TV or a Wireless Local Area Network and can get a larger rate of use of band width.

### BACKGROUND OF THE INVENTION

1. Field of the Invention

The present invention is related to a monopole broadband antenna, and especially to an improved device of antenna capable of increasing rate of use of band width and suitable particularly for use on a digital TV or a wireless communicating product.

2. Description of the Prior Art

A helix made by reeling of metallic wire is the main element of an antenna for receiving and emitting frequencies; the structure of a helix antenna can influence the functions of the antenna in all aspects. This means that the diameter of the wire, the material of the wire (such as copper plated steel), the core diameter of the helix, the pitch of the helix and the overall length all influence the functions of the antenna expected and settled.

For a set of equipment usually using such a helix antenna, for instance a mobile phone, its helix is placed in an inner through hole of an insulating outer sleeve, the helix is elastically and axially compressed to be mounted in the inner through hole of the outer sleeve, As a result of characteristics of the helix, this kind of assembly structure brings out unexpected influences on the pitch of helix and the overall length, that is, the pitch of the mounted helix is liable to change, there is a puzzle that the overall length of the helix assembled is not the same as the one settled originally. The abovementioned typical helix assembly structure, when in mass production, is especially subjected to causing each antenna to be variant in quality.

Furthermore, the mobile phone used nowadays sometimes has more than one frequency, such as a dual-frequency antenna of unique structure made by any of various methods; in the U.K. Patent No. 2, 206,243, a dual-frequency helix antenna is made from an elongate coil and a linear conductor extending into the helix antenna. However, for the design of the helix in recent days, a single helix with different dense/loose sections can be formed to have dual-frequency in which the overall length of the same helix is provided with dense winding section (the pitch is shorter) and loose winding section (the pitch is longer) in order to constitute two frequencies required. Therefore, it is important for such a helix to keep different pitches, yet the assembly structure of conventional helix antennas can destroy the settled pitch and length easily because of elastic compressing the helix, thereby it renders the necessary functions thereof to be affected.

The largest defect of such a helix antenna available now is resided in the quite low rate of use of band width (circa 5%-10%). Taking a digital TV available now as an example, although the frequencies such as used in Taiwan presently are about 460 KHZ to 860 KHZ, others such as used for GPS (Global Positioning System), WLAN (Wireless Local Area Network) etc. are all of the range of frequencies with wider bands, conventional helix antennas with lower rate of use of band width and with the limitation of tending to form larger volumes and lengths are hard to meet what is required.

### SUMMARY OF THE INVENTION

The object of the present invention is to provide a monopole broadband antenna that can get a larger rate of use of band width and narrower volume after mounting.

To get the above stated object, the present invention includes a connecting segment for connecting an antenna circuit of a set of equipment, the connecting segment is provided thereon sequentially with a shaft portion with a small diameter and a shaft portion with a large diameter in connecting with the shaft portion with the small diameter, the shaft portion with the small diameter and the shaft portion with the large diameter together form the monopole broadband antenna.

In a practical embodiment, the shaft portion with the large diameter can be solid or hollow.

The present invention will be apparent in its novelty and other characteristics after reading the detailed description of the preferred embodiment thereof in reference to the accompanying drawings. Wherein:

### BRIEF DESCRIPTION OF THE DRAWINGS

FIG. 1 is a perspective view showing an embodiment of the present invention;

FIG. 2 is a schematic view showing the embodiment in FIG. 1 is shaped by enveloping and assembling;

FIG. 3 is a standing wave ratio test graph of the present invention;

FIG. 4 is a schematic view showing a diagram of a radiation field type of an H plane under 660 MHz;

FIG. 5 is a schematic view showing a diagram of a radiation field type of an H plane under 760 MHz;

FIG. 6 is a schematic view showing a diagram of a radiation field type of an H plane under 860 MHz.

### DETAILED DESCRIPTION OF THE PREFERRED EMBODIMENT

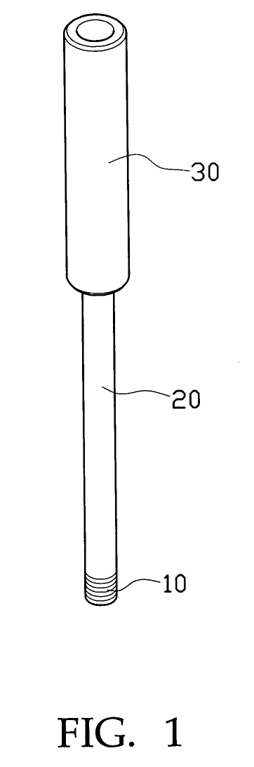

Referring to FIG. 1 firstly, in the preferable embodiment shown, the entire antenna of the present invention includes a connecting segment 10 for connecting an antenna circuit of a set of equipment, in this embodiment, the connecting segment 10 is a screw connecting segment, but it is not limited to this.

The connecting segment 10 is provided thereon sequentially with a shaft portion 20 with a small diameter and a shaft portion 30 with a large diameter in connecting with the shaft portion 20 with the small diameter, the shaft portion 20 with the small diameter and the shaft portion 30 with the large diameter together cooperatively form the monopole broadband antenna in pursuance of a set width of a ground plane. The connecting segment 10, the shaft portion 20 with the small diameter and the shaft portion 30 with the large diameter thereabove all can be made integrally of metal such as copper.

In the above preferable embodiment, the shaft portion 30 with the large diameter is solid; however it can be hollow by turning of lathe work (not shown).

And in the practical embodiment, the above shaft portion 20 with the small diameter and the shaft portion 30 with the large diameter thereabove together cooperatively forming the monopole broadband antenna not only can be in the shapes of cylinders as shown, but also can be flat plates. Otherwise, they can be in the shapes of thin tapes on a circuit board.

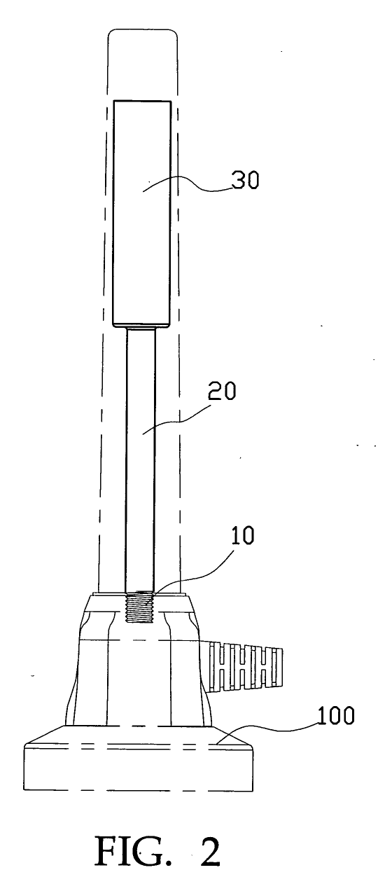

The above structure of the present invention thereby can be enveloped and shaped within a base 100 outside of the antenna, as is shown in FIG. 2, and it can form the function of antenna as desired through a related electric connecting structure, and then is ready to be assembled on the equipment (such as a digital TV set).

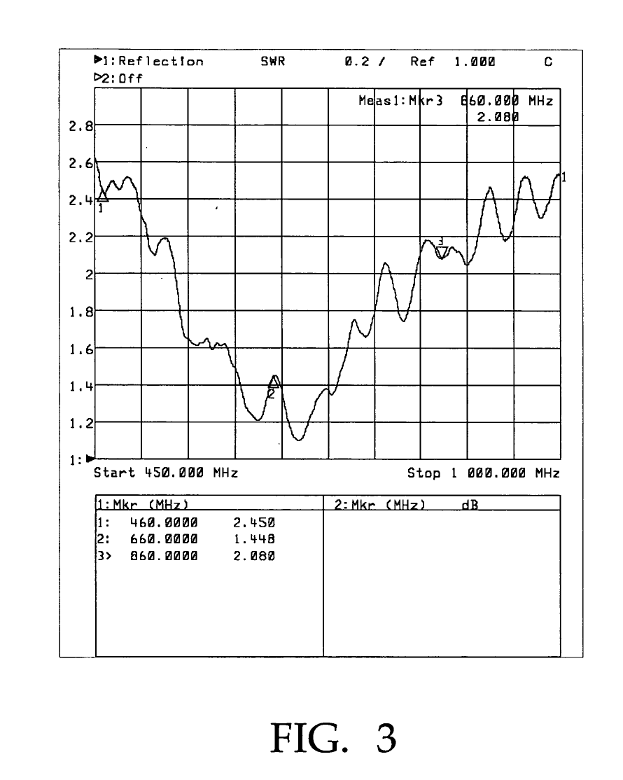

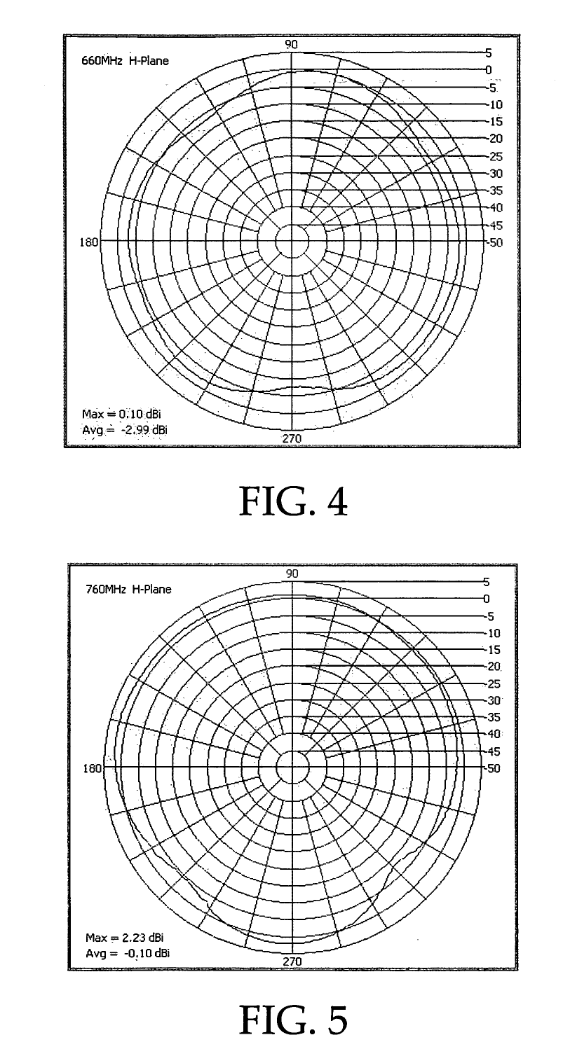

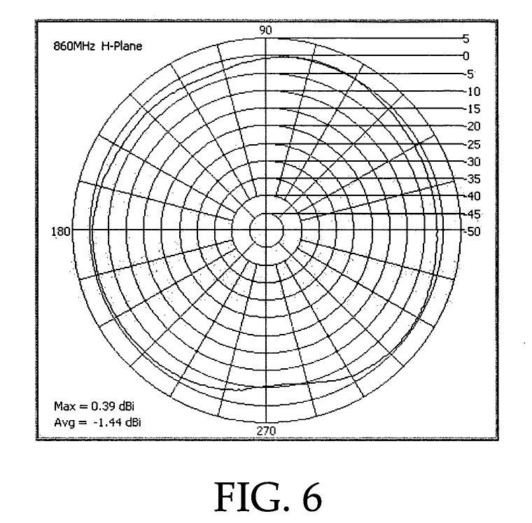

In testing the above antenna structure of the present invention, as is shown by the waveform in FIG. 3, it can be seen that its standing wave ratio (VSWR) is 2.450 under 460 MHz, 1.448 under 660 MHz and 2.080 under 860 MHz, all the standing wave ratios are smaller or slightly larger than 2, the antenna thus is an ideal broadband antenna. As shown in FIG. 4, we can see that the largest gain of the H plane under 660 MHz is 0.10 dBi, the average value is −2.99 dBi. In the case of FIG. 5 under 760 MHz, the largest gain of the H plane is 2.23 dBi, the average value is 0.10 dBi. In the case of FIG. 6 under 860 MHz, the largest gain of the H plane is 0.39 dBi, the average value is −1.44 dBi. The performance is quite outstanding. The rate of use of band width of the entire monopole broadband antenna of the present invention can exceed 50%.

By the fact that the present invention can be processed on cubic materials in a factory, thereby the factory can form the present invention to increase the superiority, lower the cost of the monopole broadband antenna, and can render the antenna to get a larger rate of use of band width and narrower volume after mounting.

The preferred embodiment disclosed above is only for illustrating the present invention and not for giving any limitation to the scope of the present invention. It will be apparent to those skilled in this art that various modifications or changes can be made to the elements of the present invention without departing from the spirit of this invention. Accordingly, all such modifications and changes also fall within the scope of the appended claims and are intended to form part of this invention.

1. A monopole broadband antenna, said antenna includes a connecting segment for connecting an antenna circuit of a set of equipment, said connecting segment is provided thereon sequentially with a shaft portion with a small diameter and a shaft portion with a large diameter in connecting with said shaft portion with said small diameter, said shaft portion with said small diameter and said shaft portion with said large diameter together cooperatively form said monopole broadband antenna in pursuance of a set width of a ground plane.

2. The monopole broadband antenna as defined in claim 1, wherein said shaft portion with said large diameter is solid.

3. The monopole broadband antenna as defined in claim 1, wherein said shaft portion with said large diameter is hollow.

4. The monopole broadband antenna as defined in claim 1, wherein said shaft portion with said small diameter and said shaft portion with said large diameter together cooperatively forming said monopole broadband antenna are in shapes of cylinders.

5. The monopole broadband antenna as defined in claim 2, wherein said shaft portion with said small diameter and said shaft portion with said large diameter together cooperatively forming said monopole broadband antenna are in shapes of cylinders.

6. The monopole broadband antenna as defined in claim 3, wherein said shaft portion with said small diameter and said shaft portion with said large diameter together cooperatively forming said monopole broadband antenna are in shapes of cylinders.

7. The monopole broadband antenna as defined in claim 1, wherein said shaft portion with said small diameter and said shaft portion with said large diameter together cooperatively forming said monopole broadband antenna are in shapes of flat plates.

8. The monopole broadband antenna as defined in claim 1, wherein said shaft portion with said small diameter and said shaft portion with said large diameter together cooperatively forming said monopole broadband antenna are in shapes of thin tapes.
